(19) United States
(12) Patent Application Publication
(10) Pub. No.: US 2011/0117290 A1
(43) Pub. Date: May 19, 2011

(54) USE OF AN ORGANOPOLYSILOXANE/POLYUREA BLOCK COPOLYMER AS A COATING ON PLASTIC SURFACES

(75) Inventors: Nicole Behrens, Munchen (DE); Frank Virus, Hamburg (DE); Bernhard Müssig, Seevetal (DE); Bernd Lühmann, Norderstedt (DE)

(73) Assignee: TESA SE

(21) Appl. No.: 12/996,877

(22) PCT Filed: Jul. 24, 2009
(86) PCT No.: PCT/EP09/59610

§ 371 Date: Jan. 26, 2011

(30) Foreign Application Priority Data
Aug. 6, 2008 (DE) 10 2008 036 518.1

(51) Int. Cl. B05D 5/10; C09D 183/10; H05H 1/24

(52) U.S. Cl. 427/536; 427/208.4; 427/208.8

(57) ABSTRACT

Use of an organopolysiloxane/polyurea block copolymer according to formula (1), where R is a univalent hydrocarbon radical with 1 to 20 carbon atoms, optionally substituted by fluorine or chlorine, X is an alkylene radical with 1 to 20 carbon atoms in which methylene units that are not adjacent to one another can be replaced by —O— groups, or is an arylene radical en with 6 to 22 carbon atoms, A is an oxygen atom or an —NR′— amino group, R′ is water or an alkyl radical with 1 to 10 carbon atoms, Y is a bivalent hydrocarbon radical with 1 to 20 carbon atoms, optionally substituted by fluorine or chlorine, B and B′ are a reactive or non-reactive end group that is bonded covalently to the polymer, n is a number from 1 to 4000 and a is a number starting from at least 10, as a coating on a pre-treated plastic surface, the polar surface energy fraction thereof being at least twice that of the untreated plastic surface.

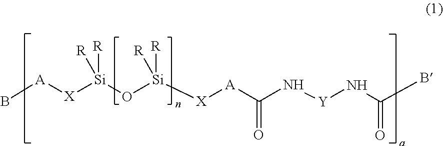

The invention relates to the use of an organopolysiloxane/polyurea block copolymer as coating on plastics surfaces.

The use of siliconized release papers and siliconized release foils in conjunction with acrylate adhesive masses and with rubber adhesive masses has been known for a long time and is widespread. However, a disadvantage is the risk of silicone transfer to surfaces, which consequently provide a poor adherent substrate for pressure-sensitive adhesives and for paints. Transfer directly to the pressure-sensitive adhesive can also take place, with a resultant reduction of adhesion. The cause of said transfer is that the curing of conventional polysiloxanes is delayed until after coating onto the release paper or onto the release foil, since the crosslinked product is insoluble. The curing is generally incomplete, and short-chain poly-siloxanes therefore remain and can be transferred to other surfaces.

In the case of organopolysiloxane/polyurea block copolymers, there is no need for subsequent crosslinking, since these are soluble in various solvents, even when they have the molecular weight necessary for release effect. To the extent that the organopolysiloxane/polyurea block copolymer is free from contaminants, no silicone transfer can therefore occur.

Copolymers having organopolysiloxane blocks and having polyurea blocks are described in I. Yilgör, Polymer, 1984 (25), 1800 and EP 0 250 248 A1. In both cases, the polydiorganosiloxane-urea block copolymers are produced in two stages. The first stage gives bisaminoalkyl-functional siloxanes, which in the second stage are reacted with isocyanates to give the block copolymer. In the process carried out by I. Yilgör however, the polydiorganosiloxane-urea block copolymers obtained are exclusively those having polysiloxane segments with molecular weights (M_{w}) of less than 4000. Furthermore, incomplete progress of the reaction leads to contaminants comprising mono- and non-functional siloxanes. In contrast, EP 0 250 248 A1 says that an equilibration reaction carried out with particular care, using specific equilibration catalysts, gives bisaminoalkyl-terminated polydimethylsiloxane chains, which have sufficient purity, even in relatively high molecular-weight ranges, to ensure that the high molecular weights required for good mechanical properties of the final polymers are obtained in the reaction with diisocyanates.

However, difunctional silicones produced by way of equilibration reactions have a number of disadvantages. At the end of the equilibration reaction, the catalyst must be either thermally deactivated or neutralized, and this results in catalyst residues, and therefore contaminants, within the final product, and these have adverse effects on the thermal stability of the resultant materials. Said contaminants are also responsible for strong intrinsic odor of the materials synthesized therefrom. Furthermore, there is also a requirement to remove about 15% of cyclic siloxanes, but this is generally not entirely possible in industry, and these cyclic siloxanes therefore remain within the product and exude from downstream products. The resultant silicones have a tendency to assume a clearly visible yellow tinge when subjected to heat treatment.

EP 1 489 129 A1 describes the production of contaminant-free organopolysiloxane/polyurea block copolymers. No catalyst has to be used in said process, and it therefore gives products which are relatively thermally stable, and also have only a slight intrinsic odor and a slight tendency to assume a yellow tinge.

U.S. Pat. No. 5,290,615 A1 describes the use of polydiorganosiloxane-urea block copolymers as release agents on adhesive tapes. However, said copolymers are produced via the disadvantageous process described in EP 0 250 248 A1, and poor aging performance therefore has to be expected. Furthermore, the copolymers comprise up to 95% by weight of a siloxane-free diamino derivative or siloxane-free dihydroxy derivative. Polydiorganosiloxane-urea block copolymers of U.S. Pat. No. 5,290,625 A1 do not adhere to untreated polyester or polyolefin surfaces. If said block copolymers are applied to such surfaces, only slight mechanical stress is required to remove them. U.S. Pat. No. 5,290,625 A1 merely describes the coating process on urethane-saturated paper.

It is therefore an object of the invention to provide a coating on a pretreated plastics surface, the polar component of the surface energy of which is at least twice as great as that of the plastics surface which is untreated but is identical in terms of the other properties, in order to improve the release property of the plastics surface, where the coating is intended to have good adhesion on the plastics surface.

Surprisingly, said object is achieved via the use of the organopolysiloxane/polyurea block copolymer described in the main claim. The dependent claims provide advantageous embodiments of the subject matter of the invention. The invention further provides use proposals for the coating of the invention.

Accordingly, the invention provides use of an organopolysiloxane/polyurea block copolymer of formula 1

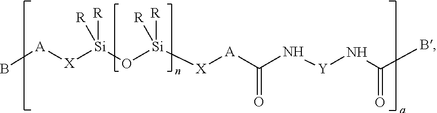

where
R are a monovalent, if appropriate fluorine- or chlorine-substituted hydrocarbon moiety having from 1 to 20 carbon atoms,
X are an alkylene moiety having from 1 to 20 carbon atoms, in which methylene units that are not adjacent to one another can have been replaced by —O— groups, or are an arylene moiety having from 6 to 22 carbon atoms,
A are an oxygen atom or an amino group —NR′—,
R′ are hydrogen or an alkyl moiety having from 1 to 10 carbon atoms,
Y are a divalent, if appropriate fluorine- or chlorine-substituted hydrocarbon moiety having from 1 to 20 carbon atoms,
B and B′ are a reactive or unreactive terminal group, covalently bonded to the polymer,
n is a number from 1 to 4000, and
a is a number which is at least 10,
   as coating on a pretreated plastics surface, the polar component of the surface energy of which is at least twice as great as that of the untreated plastics surface.

In one first advantageous embodiment of the invention, an organopolysiloxane/polyurea block copolymer is used which, as described in EP 1 489 129 A1, is polymerized in a reaction which proceeds in a single stage without use of any catalyst.

R is preferably a monovalent hydrocarbon moiety having from one to six carbon atoms, in particular unsubstituted. Methyl is particularly preferred as moiety R.

X is preferably an alkylene moiety having from two to ten carbon atoms. It is preferable that the alkylene moiety X has no interruption. It is particularly preferable that the moiety X is propylene.

It is preferable that A is an NH group.

It is preferable that Y is a hydrocarbon moiety having from 3 to 13 carbon atoms, and which preferably has no substitution. It is preferable that Y is an aralkylene moiety, or linear or cyclic alkylene moiety.

It is preferable that B is a functional or non-functional organic or organosilicon moiety. By way of example, B is an organosilyl group, for example an alkylsilyl, alkoxysilyl, or oximosilyl group, in particular having from 1 to 4 carbon atoms, an example being a methoxy group or ethoxysilyl group, hydrogen, or an acyl group, all of which have bonding by way of covalent bonds to the polymer. B can moreover be a moiety capable of free-radical or ionic polymerization, an example being a vinyl, acrylic, methacrylic, acylamide, or methacrylamide moiety, or else an epoxy moiety, an example being a propylene oxide moiety. B can moreover be an unsubstituted or substituted alkyl group preferably having from 1 to 20 carbon atoms, an unsubstituted or substituted aryl group preferably having from 6 to 22 carbon atoms, or an alkylaryl group which can be a substituted or unsubstituted group. It is particularly preferable that B is a methoxysilyl group, ethoxysilyl group, hydrogen, an aminoalkyl group, or an isocyanate-containing group. The moieties A and B can moreover form an isocyanate moiety.

B′ is preferably a functional or nonfunctional organic or organosilicon moiety. By way of example, B′ is an organosilyl group, hydrogen, an aminoalkyl group, a hydroxy group, or an NCO group, all of which have bonding to the polymer by way of covalent bonds. B′ can moreover be a moiety capable of free-radical or ionic polymerization, an example being a vinyl, acrylic, methacrylic, acylamide, or methacrylamide moiety, or else an epoxy moiety, an example being a propylene oxide moiety. B′ can moreover be an unsubstituted or substituted alkyl group preferably having from 1 to 20 carbon atoms, an unsubstituted or substituted aryl group preferably having from 6 to 22 carbon atoms, or an alkylaryl group which can be a substituted or unsubstituted group. It is particularly preferable that B′ is a methoxysilyl group, ethoxysilyl group, hydrogen, an aminoalkyl group, a hydroxy group, or an isocyanate-containing group.
n is preferably a number which is at least 3, in particular at least 25, and preferably at most 800, in particular at most 400, particularly preferably at most 250.
a is preferably a number which is at most 50.

The polydiorganosiloxanediamine used preferably comprises one of the general formula 2

H₂N—X—[SiR₂O]ₙSiR₂—X—NH₂,

where the definitions of R, X and n are as stated above.

The amount of urea groups present in the copolymer of the general formula 1, based on the entirety of urethane groups and urea groups, is preferably at least 50 mol %, particularly preferably at least 75 mol %.

The polyisocyanate used preferably comprises a diisocyanate of the general formula 3

OCN—Y—NCO,

where the definition of Y is as stated above.

Examples of the diisocyanates to be used of the general formula 3 are aliphatic compounds such as isophorone diisocyanate, hexamethylene 1,6-diisocyanate, trimethylhexamethylene 2,2,4- and 2,4,4-diisocyanate, cyclohexylene diisocyanate, tetramethylene 1,4-diisocyanate, and methylenedicyclohexyl 4,4′-diisocyanate, or aromatic compounds such as methylene-diphenyl 4,4′-diisocyanate, toluene 2,4-diisocyanate, toluene 2,5-diisocyanate, toluene 2,6-diisocyanate, m-phenylene diisocyanate, p-phenylene diisocyanate, m-xylene diisocyanate, tetramethyl-m-xylene diisocyanate, mixtures of said isocyanates, or capped types. An example of compounds of this type that are commercially available is provided by the diisocyanates of the DESMODUR® line (H, I, M, T, W) from Bayer AG, Leverkusen, Germany, or the Vestanat line from Evonik Degussa GmbH, Dusseldorf, Germany. Preference is given to aliphatic diisocyanates in which Y is an alkylene moiety, since these copolymers give better UV resistance, and this is advantageous when the polymers are used outdoors.

The organopolysiloxane/polyurea block copolymer used in the invention is by way of example soluble in anhydrous isopropanol, methyl ethyl ketone, and tetrahydrofuran.

In another advantageous embodiment of the invention, the plastics surface is a surface physically pretreated, for example via flame treatment, corona treatment, or plasma treatment.

Another pretreatment of the invention, for polyethylene terephthalate surfaces, is etching with trichloroacetic acid.

Examples of plastics surfaces are the surfaces of biaxially oriented polyethylene terephthalate, polybutene, polypropylene, monoaxially oriented polypropylene, or biaxially oriented polypropylene, or polyethylene.

In order to ensure ideal adhesion of the organopolysiloxane/polyurea block copolymer on the plastics surface, the polar component of the surface energy of the plastics surface has to be at least twice as great, after the physical pretreatment, as that of the plastics surface which has not been treated but is identical in terms of the other properties. The polar component of the surface energy is defined as that component which derives from the different electronegativities of various atoms within the same molecule. The surface energy of a substance is composed of the sum of the polar and the disperse component. The disperse component describes that component of the surface energy that results from the attractive forces between uncharged, unpolarized atoms and molecules.

The coating acts as release agent by virtue of its antiadhesive properties.

It is preferable that the plastics surface is a plastics foil, onto which the coating is preferably applied in the form of continuous layer.

Preference is further given to the presence of a pressure-sensitive-adhesive mass on that free side of the plastics foil that is opposite to the coating with organopolysiloxane/polyurea block copolymer, the result therefore being a single-side-adhesive tape, in which the coating acts as release agent.

The adhesive-mass layer arranged on the backing foil is preferably a layer made of acrylate adhesive mass, of polyurethane adhesive mass, or of rubber adhesive mass.

For the adhesive-tape application, the backing foil is monolaterally coated with the preferred pressure-sensitive adhesive in the form of solution or dispersion or at 100% strength (e.g. melt), or via coextrusion with the foil. As an alternative, lamination can be used for coating via transfer of an adhesive-mass layer. The adhesive layer(s) can be crosslinked via heat or high-energy radiation and, if necessary, can be covered with release foil or release paper.

In order to optimize properties, the self-adhesive mass used can preferably have been blended with one or more additives, examples being tackifiers (resins), plasticizers, fillers, pigments, UV absorbers, light stabilizers, antioxidants, crosslinking agents, cross-linking promoters, or elastomers.

The amount of the adhesive layer is preferably from 10 to 120 g/m², with preference from 25 to 100 g/m² (this being the amount after any necessary removal of water or solvent; the numerical values also correspond approximately to the thickness in μm).

The pressure-sensitive adhesive to be used for mono-lateral application to the backing foil is particularly preferably a pressure-sensitive polyacrylate adhesive mass which encompasses a polymer which, based on the polymer, encompasses
from 79 to 100% (w/w) of acrylate and/or meth-acrylate and/or free acids of these having the formula CH₂═C(R³)(COOR⁴), where R³ is H and/or CH₃ and R⁴ is H and/or alkyl chains having from 1 to 30 carbon atoms, and
from 0 to 30% (w/w) of olefinically unsaturated monomers having functional groups,
   where the weight data are based on the polymer. Pressure-sensitive polyacrylate adhesive masses are preferred in the invention over other adhesive masses, e.g. natural rubber adhesive masses or synthetic rubber adhesive masses, since the antiadhesive effect of the organopolysiloxane/polyurea block copolymer is strongest in conjunction with pressure-sensitive polyacrylate adhesive masses.

Physical pretreatment of that side of the backing foil that is to be coated with pressure-sensitive-adhesive mass is advantageous in order to improve adhesion, for example via flame treatment, plasma treatment, or corona treatment.

If necessary, prior to the application of the pressure-sensitive-adhesive layer on the backing foil, it is possible to apply a primer layer, in particular without solvent, for example via coextrusion, so that there is a primer layer located between the backing-foil layer and a pressure-sensitive-adhesive layer.

The invention also encompasses adhesive tapes described in the invention which also have at least one functional layer which is immediately, or not immediately, adjacent to the backing layer.

By way of example, it is possible here to use a primer layer between backing layer and adhesive-mass layer, or a layer of a colored coating material between backing layer and organopolysiloxane/polyurea block copolymer, or in the form of exterior layer on the organopolysiloxane/polyurea block copolymer. It is advantageous to use a primer layer between backing layer and adhesive mass in order to improve the adhesion of the adhesive mass on the backing layer and thus to improve the avoidance of transfer of adhesive to the reverse side of the foil during unwinding of the rolls.

Primers that can be used are the known dispersion-medium systems and the known solvent systems, examples being those based on isoprene rubbers or on butadiene-containing rubbers, and/or on cyclic rubbers. Isocyanates or epoxy resins in the form of additives improve adhesion and sometimes also increase the shear resistance of the pressure-sensitive adhesive. Physical surface treatments, such as flame treatment, corona treatment, or plasma treatment, or coextruded layers, are likewise suitable for improving adhesion. It is particularly preferable to use abovementioned processes with use of solvent-free adhesive layers, in particular those based on acrylate.

Descriptions of the usual primers are found by way of example in “Handbook of Pressure Sensitive Adhesive Technology”, D. Satas (3rd edition).

Another possible application of the coating of the invention made of organopolysiloxane/polyurea block copolymers consists in the use as adhesion promoter (primer), in particular for the bonding of adhesive silicone masses on the plastics backing materials.

For the purposes of this invention, the general expression “adhesive tape” covers all sheet-like structures, such as the following flat structures: foils or foil sections, tapes having substantial length and restricted width, tape sections, labels, stamped-out sections, and the like.

### Test Methods

Unless otherwise stated, the measurements are made under the following test conditions: 23±1° C. and rel. humidity of 50±5%.

The density of the polymers is determined to ISO 1183 and expressed in g/cm³.

The crystallite melting point (T_{cr}) is determined by DSC to MTM 15902 (Basell method) and, respectively, ISO 3146.

Anchoring of the coating is checked via rubbing with an index finger (respectively three times in machine direction and in transverse direction). The result is classified as follows:
very good (very good anchoring),
good (no separation, slight traces visible),
satisfactory (no separation, distinct traces visible),
poor (some, substantial, or total separation).

Separation force is determined on an adhesive bond between two test strips each of width 20 mm. The first of the test strips here is a foil coated with an organopolysiloxane/polyurea block copolymer, or an adhesive tape with corresponding reverse-side coating. The other test strip is a test adhesive tape with product number Tesa® 7475, Tesa® 7476, or Tesa® 4579.

Tesa® 7475 is an adhesive tape using a PVC foil as backing, to which an acrylate mass has been applied (adhesion on steel: 31.25 N/25 mm). Tesa® 7476 is an adhesive tape using a cotton textile as backing, to which a rubber mass has been applied (adhesion on steel: 25 N/25 mm). Tesa® 4579 is a longitudinally and transversely reinforced filament adhesive tape based on a PP foil with adhesion of 8 N/cm on steel.

The second test adhesive tape is always adhesive-bonded to that side of the first test strip that had organopolysiloxane/polyurea block copolymer coating. Prior to the measurement, the specimen is aged for 24 hours at 40° C. (for Tesa® 7476 and Tesa® 4579) or 70° C. (Tesa® 7475) under a load of 2 N/cm². After the aging process, the test strips are cut to size to a length of 220 mm and aged under the test conditions for 2 hours. For the measurement, the upper test strip of the adhesive bond is clamped into the upper clamping jaw of a tensile-testing machine, as used in AFERA 4001. The lower test strip is clamped in the lower clamping jaw. The separation of the clamping jaws here is 50 mm. The velocity with which the clamping jaws are separated for the measurement is 300 mm/min. The separation force is the force needed to separate the adhesive bond, averaged over a path length of 100 mm.

The adhesions are determined at a peel angle of 180° to AFERA 4001 on (where possible) test strips of width 20 mm. Steel plates are used here as test substrate in accordance with the AFERA standard.

The reduction in adhesion is calculated from the adhesions without aging (A_{withoutaging}) and the residual adhesions after aging (A_{aging}), using the following formula:

$$Reduction of adhesion [ \% ] = \frac{{A}_{withoutaging} - {A}_{aging}}{{A}_{withoutaging}}$$

Thickness is determined to DIN 53370, the calipers being flat (not curved). However, in the case of structured foils the thickness is established prior to embossing. It is also possible to achieve this subsequently by using the weight per unit area (determined to DIN 53352) and conversion using the density. The depth of embossment is the difference between the thicknesses with and without embossment.

The examples below are intended to illustrate the invention but not to restrict its scope:

### EXAMPLES

Organopolysiloxane/polyurea block copolymers used:

Organopolysiloxane/polyurea block copolymer 1 (OPB1): block copolymer where, in the structure of formula 1,
R is methyl,
X is propylene,
A is an amino group —NH—,
B and B′ are NH₂,
n is about 42, and
a is about 20.
Y is obtained via the use of the diisocyanate methylenedicyclohexyl 4,4′-diisocyanate (H12MDI, Desmodur W® from Bayer AG, Leverkusen, Germany) of formula 3.

A very similar organopolysiloxane/polyurea block copolymer is marketed by Wacker Chemie AG, Burghausen, Germany with trade name Geniomer 140.

Organopolysiloxane/polyurea block copolymer 2 (OPB2): block copolymer where, in the structure of formula 1,
R is methyl,
X is propylene,
A is an amino group —NH—,
B and B′ are NH₂,
n is about 42, and
a is about 35.
Y is obtained via the use of the diisocyanate isophorone diisocyanate (IPDI) of formula 3.

A very similar organopolysiloxane/polyurea block copolymer is marketed by Wacker Chemie AG, Burghausen, Germany with trade name Geniomer 80.

### Inventive Example 1

OPB1 is dissolved in anhydrous isopropanol to give a 2% strength by weight solution. The solution is applied, using a wire-wound draw bar, to corona-pretreated foil (corona dose for PET: 75 Wmin/m², for polyolefins: 45 Wmin/m²) to give a theoretical application weight per unit area of 0.24 g/m². The coated sample is dried at 120° C. for 2 minutes.

A test adhesive tape is stuck to the OPB1-coated side of the resultant foil, and the composite is aged as in the test specification for separation forces, and tested.

### Inventive Example 2

OPB2 is dissolved in anhydrous isopropanol to give a 2% strength by weight solution. The solution is applied, using a wire-wound draw bar, to corona-pretreated foil (corona dose for PET: 75 Wmin/m², for polyolefins: 45 Wmin/m²) to give a theoretical application weight per unit area of 0.24 g/m². The coated sample is dried at 120° C. for 2 minutes.

Testing takes place as in inventive example 1.

### Inventive Example 3

OPB2 is dissolved in anhydrous isopropanol to give a 2% strength by weight solution. The solution is applied, using a wire-wound draw bar, to etched PET foil to give a theoretical application weight per unit area of 0.24 g/m². The coated sample is dried at 120° C. for 2 minutes.

Testing takes place as in inventive example 1.

### Inventive Example 4

### Polyacrylate Production

40 g of acrylic acid, 360 g of 2-ethylhexyl acrylate, and 133 g of acetone/isopropanol (96:4) were charged to a 2 L glass reactor conventionally used for free-radical polymerization reactions. After nitrogen gas had been passed through the system for 45 minutes, with stirring, the reactor was heated to 58° C., and 0.2 g of azoisobutyronitrile (AIBN, Vazo 64®, DuPont) was added. The exterior heating bath was then heated to 75° C., and the reaction was carried out under constant conditions at this external temperature. After 1 h of reaction time, another 0.2 g of AIBN was added. After 4 and 8 h, 100 g of acetone/isopropanol (96:4) mixture were respectively used for dilution. In order to reduce the residual amount of initiators, 0.6 g of bis(4-tert-butylcyclohexanyl) peroxydicarbonate (Perkadox 16®, Akzo Nobel) was added respectively after 8 and after 10 h. After 24 h of reaction time, the reaction was terminated and the system was cooled to room temperature. The polyacrylate is blended with 0.4% by weight of aluminum(III) acetylacetonate (3% by weight strength solution in isopropanol), and diluted with isopropanol to 30% solids content.

### Coating

OPB1 is dissolved in anhydrous isopropanol to give a 1% strength by weight solution. The solution is applied, using a wire-wound draw bar, to corona-pretreated MOPP foil (40 μm, corona dose: 33 Wmin/m²) to give a theoretical application weight per unit area of 0.24 g/m². The coated sample is dried at 120° C. for 2 minutes.

In a second coating pass, the second, as yet uncoated side, is likewise corona-treated (dose: 33 Wmin/m²), and is then coated with the polyacrylate solution. The application weight per unit area after drying for 20 minutes at 90° C. was 50 g/m². The resultant adhesive tape is wound into short-length production-width rolls.

This adhesive tape is unwound and then a test adhesive tape is stuck to the OPB1-coated side thereof. The adhesive-mass-coated side is covered by a PVC foil, and the composite is aged as in the test specification for separation forces, and tested.

### Comparative Example 1

OPB2 is dissolved in anhydrous isopropanol to give a 2% strength by weight solution. The solution is applied, using a wire-wound draw bar, to untreated plastics foil to give a theoretical application weight per unit area of 0.24 g/m². The coated sample is dried at 120° C. for 2 minutes.

Testing takes place as in inventive example 1.

### Comparative Example 2

OPB1 is dissolved in anhydrous isopropanol to give a 2% strength by weight solution. The solution is applied, using a wire-wound draw bar, to untreated PET foil and MOPP foil to give a theoretical application weight per unit area of 0.24 g/m². The coated sample is dried at 120° C. for 2 minutes.

Testing takes place as in inventive example 1.

TABLE 1
List of foils used.

| | Trade name | Producer |
|---|---|---|
| PE | Polymer: | ExxonMobil Chemical, |
| | ExxonMobil LD251 | Machelen, Belgium |
| PE ionomer | Polymers: | ExxonMobil Chemical, |
| | ExxonMobil LD251 (25%) | Machelen, Belgium |
| | Ineos Novex M21E760 (75%) | Ineos, Lyndhurst, UK |
| PP | Polymer: | Borealis, Vienna, |
| | Borealis HD905CF | Austria |
| MOPP | PPK, natur | Nowofol, Siegsdorf, |
| | | Germany |
| BOPP | GND 50 | Treofan, Raunheim, |
| | | Germany |
| PET | Hostaphan RN75 | Mitsubishi Polyester |
| | | Film, Wiesbaden, |
| | | Germany |
| PET, etched | Polibond D23H | Polifibra, Limburg, |
| | | Germany |

The PE foil, the PE ionomer foil, and the PP foil were produced in-house.

### Comparison of Properties

TABLE 2
Surface energies, anchoring of coating, and separation forces for the foils used.

| | | | Surface | Polar | | Separation forces | | |
|---|---|---|---|---|---|---|---|---|
| | Ex. | | energy | component | | tesa | tesa | tesa |
| | No. | Polymer | σ [mN/m] | [mN/m] | Anchoring | 7475 | 7476 | 4579 |
| OPB2 | c1 | PE | 25.8 | 0.3 | poor | | | |
| | 2 | PE* | 43.8 | 8.0 | very good | 1.3 | 4.0 | |
| | c1 | PE ionomer | 32.6 | 0.9 | poor | | | |
| | 2 | PE ionomer* | 40.4 | 7.3 | very good | 1.5 | 4.1 | |
| | c1 | PP | 31.0 | <0.1 | poor | | | |
| | 2 | PP* | 40.0 | 9.1 | good | 1.2 | 3.7 | |
| | c1 | BOPP | 26.7 | 1.3 | | | | |
| | 2 | BOPP* | 33.3 | 8.8 | very good | 1.2 | 3.8 | |
| | c1 | PET | 46.2 | 8.1 | poor | | | |
| | 2 | PET* | 52.5 | 20.1 | good | 1.2 | 3.3 | |
| | 3 | PET, etched | 43.0 | 25.1 | very good | 1.3 | 3.2 | |
| OPB1 | c2 | PET | 46.2 | 8.1 | poor | | | |
| | 1 | PET* | 52.5 | 20.1 | good | 0.5 | 2.6 | |
| | c2 | MOPP | 27.7 | 1.6 | poor | | | |
| | 4 | MOPP* | 36.3 | 4.5 | very good | 0.5 | 3.0 | 2.8 |
| | 1 | BOPP* | 33.3 | 8.8 | very good | 0.2 | | |

*after corona treatment

In all of the measurements, reduction of adhesion was at most 11%.

Comparison of the surface energies of the untreated foils listed in table 2 shows marked polymer-dependency. Polyethylene terephthalate foils in particular have very high surface energy, about 46 mN/m, even when untreated. Despite said high surface energy, the anchoring of the organopolysiloxane/polyurea block copolymer on the untreated PET foil is poor. This problem is solved by the physical pretreatment, which increases the surface energy to 53 mV/m, and in particular the polar component of the surface energy here is raised from 8 to 20 mV/m. The other foils behave similarly. The physical treatment in particular increases the polar component of the surface energy, and this component then permits effective anchoring of the organopolysiloxane/polyurea block copolymer.

The coating of the organopolysiloxane/polyurea block copolymer can be used in the invention as release agent with respect to pressure-sensitive-adhesive masses composed of polyurethane, of polyacrylate (Tesa® 7475), and of rubber (Tesa® 7476, Tesa® 4579). Table 2 shows the separation values obtained by types OPB1 and OPB2. Type OPB1 can give lower separation values than type OPB2. The lowest separation forces are achieved for the two organopolysiloxane/polyurea block copolymer types in conjunction with pressure-sensitive polyacrylate adhesive masses (Tesa® 7475). It is also desirable that the reduction of adhesion is small, and this is achieved via low content of low-molecular-weight silicones and good anchoring on the surface. Both are provided in the coating of the invention, as shown by the values for reduction of adhesion, which are at most 11% for the adhesive bonds tested. If anchoring of the organopolysiloxane/polyurea block copolymer is defective, as is the case with the untreated plastics surfaces in the comparative examples, transfer to the adhesive mass would occur, with resultant impairment of adhesion after separation from the organopolysiloxane/polyurea block copolymer.

Pretreatment of the plastics surfaces with the resultant rise in the polar component of the surface energy is therefore essential in order to permit anchoring and thus the use of the organopolysiloxane/polyurea block copolymer as release agent. The same applies to the use of the organopolysiloxane/polyurea block copolymer as adhesion promoter.

1. A method for improving the release properties of plastic surfaces comprising coating a pretreated plastics surface with an organopolysiloxane/polyurea block copolymer of formula 1 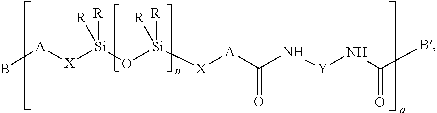
where R are a monovalent, if appropriate fluorine- or chlorine-substituted hydrocarbon moiety having from 1 to 20 carbon atoms, X are an alkylene moiety having from 1 to 20 carbon atoms, in which methylene units that are not adjacent to one another can have been replaced by —O— groups, or are an arylene moiety having from 6 to 22 carbon atoms, A are an oxygen atom or an amino group —NR′—, R′ are hydrogen or an alkyl moiety having from 1 to 10 carbon atoms, Y are a divalent, if appropriate fluorine- or chlorine-substituted hydrocarbon moiety having from 1 to 20 carbon atoms, B and B′ are a reactive or unreactive terminal group, covalently bonded to the polymer, n is a number from 1 to 4000, and a is a number which is at least 10, wherein the plastics surface has a polar component of surface energy at least twice as great as the polar component of surface energy as an untreated elastics surface.

2. The method according to claim 1 wherein the plastics surface is a physically pretreated plastics surface.

3. The method according to claim 2 wherein the plastics surface has been physically pretreated via corona treatment.

4. The method according to claim 2 wherein the plastics surface has been physically pretreated via application of a primer layer.

5. The method according to claim 1 wherein the plastics surface is biaxially oriented polyethylene terephthalate, polybutene, polypropylene, monoaxially oriented polypropylene, or biaxially oriented polypropylene, or polyethylene.

6. The method according to claim 1 wherein the plastics surface is a plastics foil.

7. The method according to claim 6 comprising a pressure-sensitive-adhesive mass present on that free side of the plastics foil that is opposite to the coating with organopolysiloxane/polyurea block copolymer.

8. The method according to claim 7 wherein the pressure-sensitive-adhesive mass is selected from the group consisting of acrylate adhesives, polyurethane adhesives, and rubber adhesives.

9. The method according to claim 8 wherein the pressure-sensitive-adhesive mass is a pressure-sensitive polyacrylate adhesive mass which encompasses a polymer which, based on the polymer, encompasses
b1) from 79 to 100% (w/w) of acrylate and/or methacrylate and/or free acids of these having the formula CH₂═C(R³)(COOR⁴), where R³ is H and/or CH₃ and R⁴ is H and/or alkyl chains having from 1 to 30 carbon atoms; and
b2) from 0 to 30% (w/w) of olefinically unsaturated monomers having functional groups.

10. The method according to claim at least one further functional layer adjacent to the backing layer.

11. The method according to claim 1 wherein the organopolysiloxane/polyurea block copolymer is polymerized in a reaction which proceeds in a single stage.

12. The method according to claim 1 wherein R is a monovalent hydrocarbon moiety having from one to six carbon atoms.

13. The method according to claim 1 wherein X is an alkylene moiety having from two to ten carbon atoms.

14. The method according to claim 1 wherein A is an NH group.

15. The method according to claim 1 wherein Y is a hydrocarbon moiety having from 3 to 13 carbon atoms.

16. The method according to claim 1 wherein n is a number which is at least 3.

17. The method according to claim 1 wherein a is a number which is at most 50.

18. The method according to claim 1 wherein the coating is used as adhesion promoter.
